(19) United States
(12) Patent Application Publication
(10) Pub. No.: US 2014/0015438 A1
(43) Pub. Date: Jan. 16, 2014

(54) TUNABLE LIGHT SYSTEM AND ASSOCIATED METHODS

(71) Applicant: LIGHTING SCIENCE GROUP CORPORATION, (US)

(72) Inventors: Fredric S. Maxik, Indialantic, FL (US); David E. Bartine, Cocoa, FL (US); Robert R. Soler, Cocoa Beach, FL (US); Matthew Regan, Melbourne, FL (US); Valerie A. Bastien, Melbourne, FL (US)

(73) Assignee: LIGHTING SCIENCE GROUP CORPORATION, Sattellite Beach, FL (US)

(21) Appl. No.: 13/737,606

(22) Filed: Jan. 9, 2013

Related U.S. Application Data
(60) Provisional application No. 61/643,308, filed on May 6, 2012.

(51) Int. Cl. H05B 33/08

(52) U.S. Cl. CPC H05B 33/0842; H05B 33/0863
USPC 315/292; 315/297

(57) ABSTRACT

Methods of tuning a luminaire having a first light source, a second light source, and a third light source, wherein each light source produces a different color of light including receiving a selected warmth, include the step of determining whether the light emitted by the first light source matches the amount of light needed from the first light source to match the selected warmth. It may be determined whether the first and second light sources are emitting sufficient light, and each may be adjusted to emit light having the selected warmth.

### RELATED APPLICATIONS

This application is related to and claims the benefit under 35 U.S.C. §119(e) of U.S. Provisional Patent Application Ser. No. 61/643,308 filed May 6, 2012, titled TUNABLE LIGHT SYSTEM AND ASSOCIATED METHODS, and is also related to U.S. patent application Ser. No. 13/234,371 filed Sep. 16, 2011, titled COLOR CONVERSION OCCLUSION AND ASSOCIATED METHODS, U.S. patent application Ser. No. 13/107,928 filed May 15, 2011, titled HIGH EFFICACY LIGHTING SIGNAL CONVERTER AND ASSOCIATED METHODS, and U.S. patent application Ser. No. 13/310,300 filed Dec. 5, 2011, titled TUNABLE LED LAMP FOR PRODUCING BIOLOGICALLY-ADJUSTED LIGHT, the entire contents of each of which are incorporated herein by reference.

### FIELD OF THE INVENTION

The present invention relates to the field of lighting devices and, more specifically, to tunable lighting devices that allow customization of a light source.

### BACKGROUND OF THE INVENTION

Current lighting devices, while becoming increasingly more energy efficient, lack the ability to effectively adapt to their respective environments. Should a lighting device have the ability to effectively adapt to its environment, the lighting device may become more efficient, which is more desirable to both consumers and producers. Additionally, should the environment of the lighting device be changed, for instance, from a warm, inviting family room to a cool, private sanctuary, it may be advantageous to have a lighting device that allows for proper lighting of the environment without necessitating the need to buy additional lighting devices. Therefore, a need exists for a lighting device with the ability to “tune” its warmth to its environment.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the foregoing in mind, embodiments of the present invention are related to methods of tuning a luminaire having a first light source, a second light source, and a third light source, wherein each light source produces a different color of light. The method may comprise the steps of operating each of first light source, the second light source, and the third light source, receiving a selected warmth, determining whether the light emitted by the first light source matches the amount of light needed from the first light source to match the selected warmth. A determination that the light emitted by the first light source does not match the amount of light needed from the first light source may result in operating the first light source to emit the amount of light needed from the first light source to match the selected warmth and determining whether the light emitted by the second light source matches the amount of light needed from the second light source to match the selected warmth. A determination that the light emitted by the second light source does not match the amount of light needed from the second light source may result in operating the second light source to emit the amount of light needed from the second light source to match the selected warmth, and determining whether the light emitted by the third light source matches the amount of light needed from the third light source to match the selected warmth. A determination that the light emitted by the third light source does not match the amount of light needed from the third light source may result in operating the third light source to emit the amount of light needed from the third light source to match the selected warmth.

Other embodiments of the present invention are related to methods of tuning a luminaire having a first light source, a second light source, and a third light source using a computerized device having a user interface. The method may comprise the steps of operating each of first light source, the second light source, and the third light source, receiving a selected warmth via the user interface, and determining whether the light emitted by the first light source matches the amount of light needed from the first light source to match the selected warmth. A determination that the light emitted by the first light source does not match the amount of light needed from the first light source may result in operating the first light source to emit the amount of light needed from the first light source and determining whether the light emitted by the second light source matches the amount of light needed from the second light source to match the selected warmth. A determination that the light emitted by the second light source does not match the amount of light needed from the second light source may result in operating the second light source to emit the amount of light needed from the second light source to match the selected warmth and determining whether the light emitted by the third light source matches the amount of light needed from the third light source to match the selected warmth. A determination that the light emitted by the third light source does not match the amount of light needed from the third light source may result in operating the third light source to emit the amount of light needed from the third light source, receiving a selected dominant color, and adjusting the selected warmth to include the selected dominant color.

Other embodiments of the present invention are related to a tunable lighting system comprising a luminaire, which in turn may comprise a mint-white light-emitting diode (LED), a first colored LED, a second colored LED, and a controller; The lighting system may further comprise a computerized device positioned in communication with the controller and configured to control the operation of each of the mint-white LED, the first colored LED, and the second colored LED. The computerized device may comprise a user interface configured to receive a selected warmth. The controller is programmable to operate the LEDs of the luminaire responsive to the selected warmth.

### BRIEF DESCRIPTION OF THE DRAWINGS

FIG. 1 is a cross-sectional view of a luminaire according to an embodiment of the present invention.

FIG. 2 is a cross-sectional view of a luminaire according to an alternate embodiment of the present invention.

FIG. 3 is a flowchart detailing a process of operating a luminaire according to an embodiment of the present invention.

FIG. 4 is a flowchart detailing a process of operating a luminaire according to an embodiment of the present invention.

FIG. 5 is a schematic diagram of an exemplary user interface to operate a luminaire according to an embodiment of the present invention.

FIG. 6 is a schematic diagram of an exemplary user interface to operate a luminaire according to an alternate embodiment of the present invention.

FIG. 7 is a flowchart detailing a process of operating a luminaire according to an embodiment of the present invention.

FIG. 8 is a block diagram of an exemplary computing device for use with the luminaire according to an embodiment of the present invention.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Additionally, in the following detailed description, reference may be made to the driving of light emitting diodes, or LEDs. A person of skill in the art will appreciate that the use of LEDs within this disclosure is not intended to be limited to the any specific form of LED, and should be read to apply to light emitting semiconductors in general. Accordingly, skilled artisans should not view the following disclosure as limited to the any particular light emitting semiconductor device, and should read the following disclosure broadly with respect to the same.

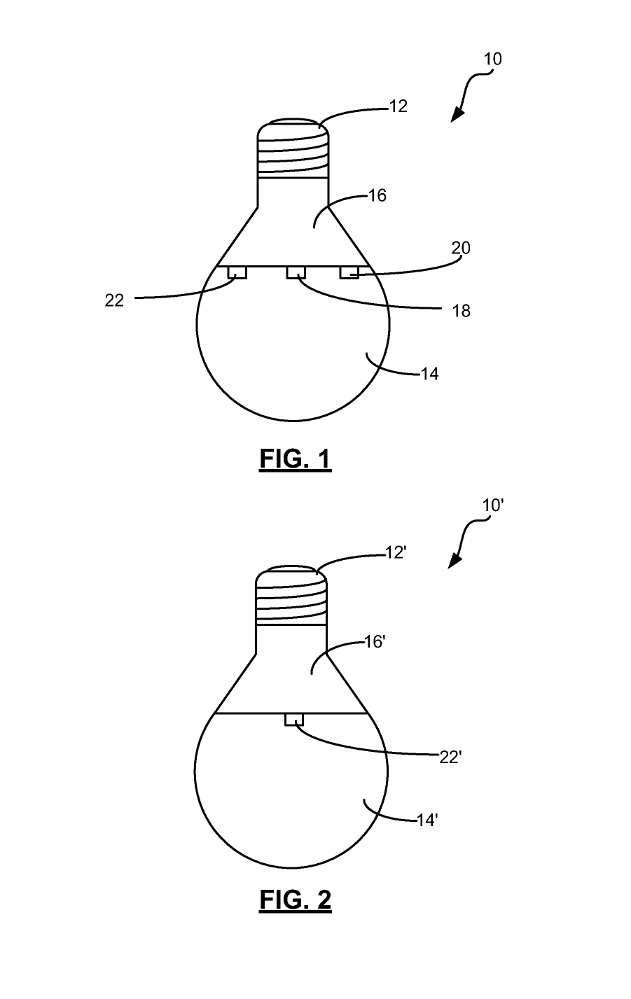

Referring now to FIGS. 1-7, a tunable luminaire 10 and methods of operating the same will be discussed. Referring initially to FIG. 1, a tunable luminaire 10 is shown having an electrical base 12, an enclosure 14, and an intermediate member 16 between the electrical base 12 and the enclosure 14. As shown in FIG. 1, the enclosure 14 may house a mint white LED 18, a bluish white LED 20, and an amber LED 22 that is carried by the intermediate member 16. The inclusion of these LEDs may advantageously allow a user to select any desired warmth of the light emitted from the luminaire 10 such as, cool bluish white, to a minty white, to a warm amber white. Further, depending on the intensity with which each of the LEDs 18, 20, 22 is illuminated, the warmth of the light emitted from the luminaire 10 may be readily adjusted to any warmth using any combination of the three LEDs to advantageously allow a user to set the luminaire to emit a custom warmth.

Referring additionally to FIG. 2, an alternate embodiment of the tunable luminaire 10′ is shown. The luminaire 10′ may include an electrical base 12′, an enclosure 14′, and an intermediate member 16′ between the electrical base 12′ and the enclosure 14′. The enclosure 14′ may house a single tunable amber LED 22′ that is carried by the intermediate member 16′. Although not pictured, it is contemplated that the enclosure 14′ may alternately house a single tunable mint white LED 18′ carried by the intermediate member 16′, or a single tunable bluish white LED 20′ carried by the intermediate member 16′, rather than a single tunable amber LED 22′. The inclusion of only one tunable LED may allow for custom linear tuning.

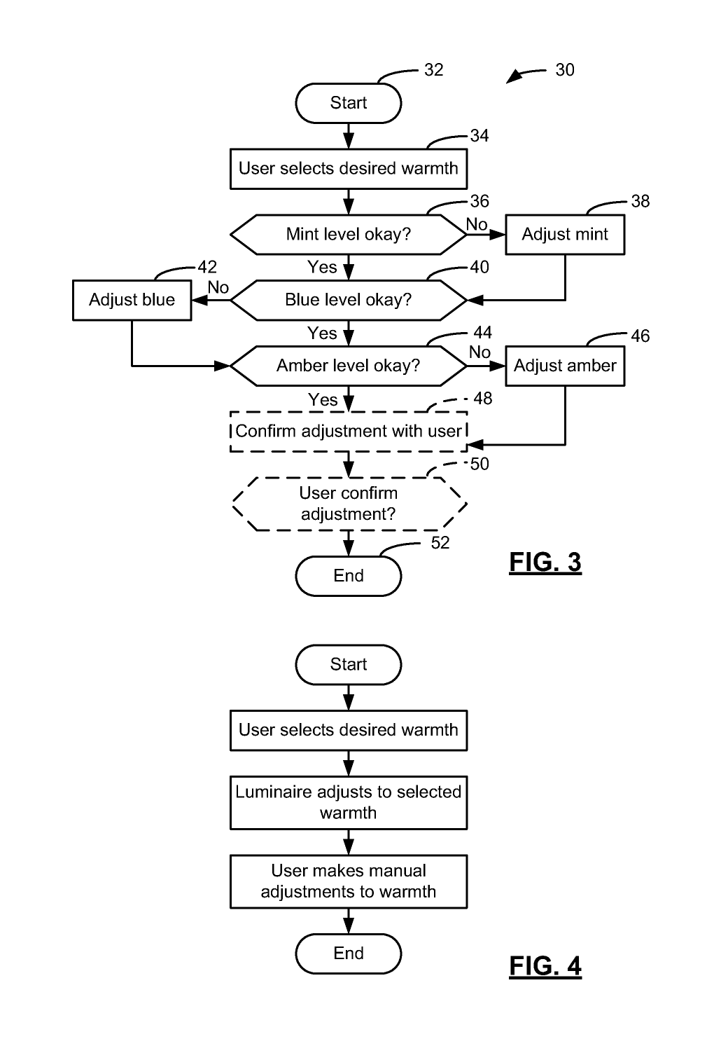

Referring now to flowchart 30 of FIG. 3, a method of tuning the luminaire 10 that is illustrated in FIG. 1 will now be discussed. Beginning at Block 32, the user may select a desired warmth at Block 34. The luminaire 10 may check if the amount of light coming from the mint white LED 18 matches the amount of light needed from the mint white LED 18 to match the desired warmth (Block 36). If the amounts do not match, the mint white LED 18 may be adjusted to match the amount required for the desired warmth (Block 38). If the amount required from the mint white LED 18 matches at Block 36 or Block 38, the it may then be determined if the amount of light coming from the bluish white LED 20 matches the amount of light needed from the bluish white LED 20 to match the desired warmth (Block 40). If the amounts do not match, the bluish white LED 20 may be adjusted to match the amount required for the desired warmth (Block 42). If the amount required from the bluish white LED 20 matches at Block 40 or Block 42, the luminaire 10 may then check if the amount of light coming from the amber LED 22 matched the amount of light needed from the amber LED 22 to match the desired warmth (Block 44). If the amounts do not match, the amber LED 22 may be adjusted to match the amount required for the desired warmth (Block 46). If the amount required from the amber LED 22 matches at Block 44 or Block 46, the tuning of the luminaire 10 may be completed at Block 52. A user interface may optionally be included to present a confirmation message to a user at Block 48. The user may optionally confirm the chosen warmth at Block 50, ending the process at Block 52, or the user may select an option to choose a different desired warmth at Block 50, returning the process to Block 34.

A skilled artisan having had the benefit of this disclosure may readily recognize that the order of checking and adjusting the LEDs need not necessarily be the order outlined above, and may be done in any order that allows all of the LEDs to be checked and adjusted. Referring now to flowchart 60 FIG. 4, an alternate method of adjusting the warmth of the luminaire 10 according to an alternate embodiment of the present invention will now be discussed. Starting at Block 62, the user may select a desired warmth (Block 64). The luminaire may then be adjust to the selected warmth (Block 66), after which a user may make manual adjustments until he or she is satisfied (Block 68), ending the method (Block 70).

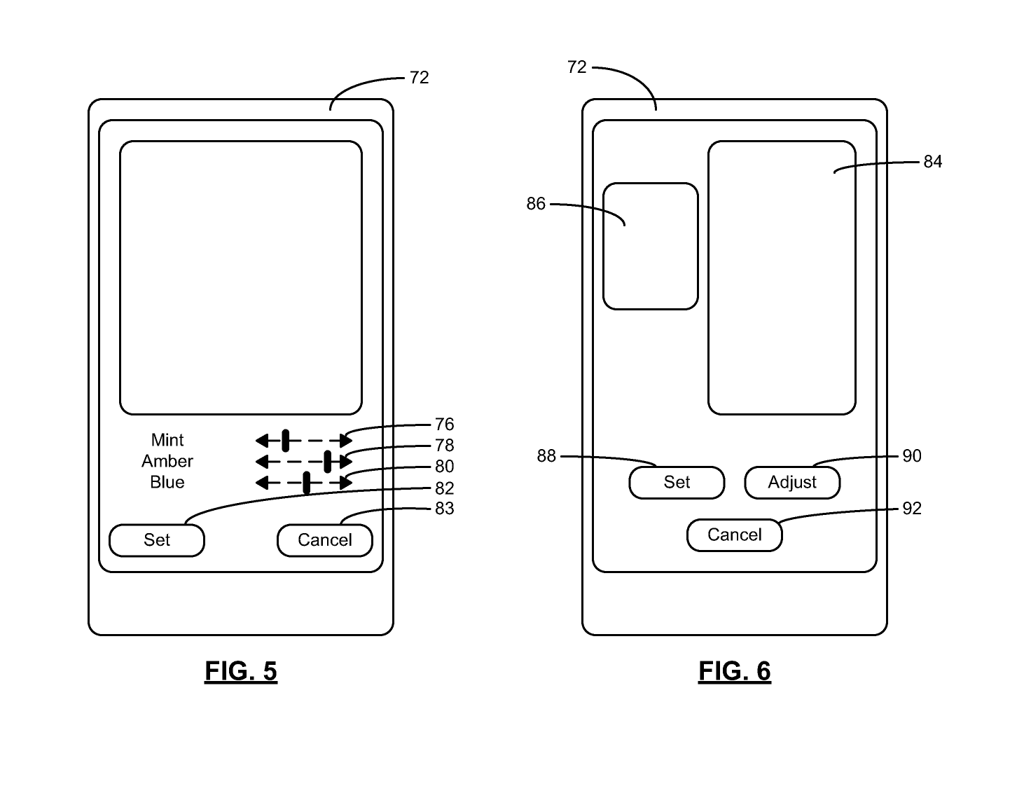

Referring now to FIG. 5, an exemplary user interface is presented as a mobile phone 72 or other handheld device. The mobile phone 72 may include an estimated image 74 which shows the projected warmth of an environment as selected by a user before making any adjustments. A mint slider 76, an amber slider 78, and a blue slider 80 are also provided to allow for individual adjustments to the warmth. Once the user has selected a desired warmth and is satisfied with the estimated image, the user may press a set button 82. If the user wishes to not make any changes, or start over, a cancel button 83 may additionally be provided. Those skilled in the art will appreciate that this is but one version of a user interface that may be used. It is contemplated, for example, that the user interface may not include a projected estimated environment after tuning 74 and may, instead, simply send a signal to adjust the luminaire 10 as the luminaire is being adjusted using the sliders 76, 78, 80. Further, it is contemplated that the user interface may be provided by an application that is downloadable and installable on a mobile phone and over a mobile phone (other other handheld device) network. Further, it is contemplated that a range of warmths may be presented to a user, instead of the plurality of sliders 76, 78, 80, and that the user may simply select a warmth within the range as desired.

Of course, those skilled in the art will appreciate that the luminaire is positioned in communication with a network and includes a controller in order to communicate with such a user interface. Additional information regarding a luminaire that is positioned in communication with a network can be found, for example, in U.S. Provisional Patent Application Ser. No. 61/486,314 titled Wireless Lighting Device and Associated Methods, as well as U.S. patent application Ser. No. 13/463,020 titled Wireless Pairing System and Associated Methods, and the entire contents of each of which are incorporated herein by reference.

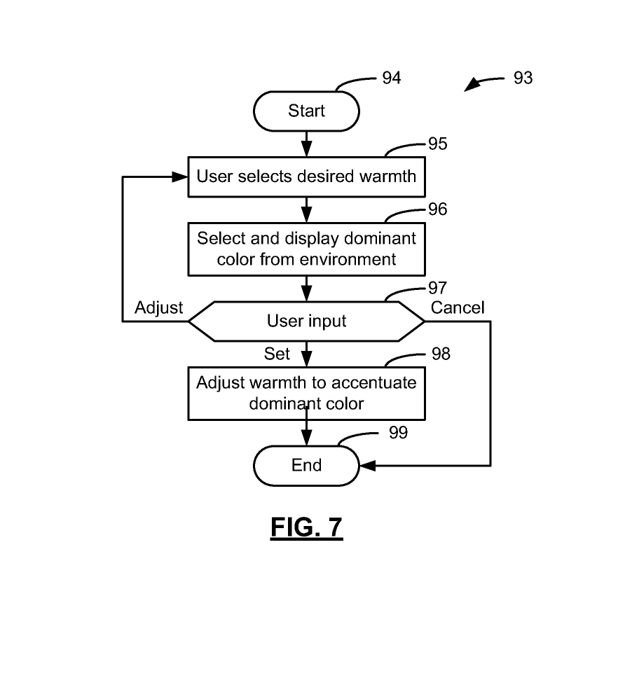

Referring now to FIG. 6, and additionally FIG. 7, an alternate exemplary user interface and method of using the same will now be discussed. Beginning at Block 94 of flowchart 93, the user may capture an image of the environment 84 with the mobile phone 72, or other handheld device (Block 95). An application on the mobile phone 72 may pick out a dominant color 86 from the environment and display it to the user at Block 96. The application may then wait for user input at Block 97. The user may choose the adjust button 90 to recapture an image of the environment 84, returning the operation to Block 95. The user may alternately cancel the operation using the cancel button 92, ending the operation at Block 99. If, however, the user selects the set button 88, the luminaire 10 may adjust its warmth to accentuate the dominant color 86 (Block 98), ending the operation (Block 99).

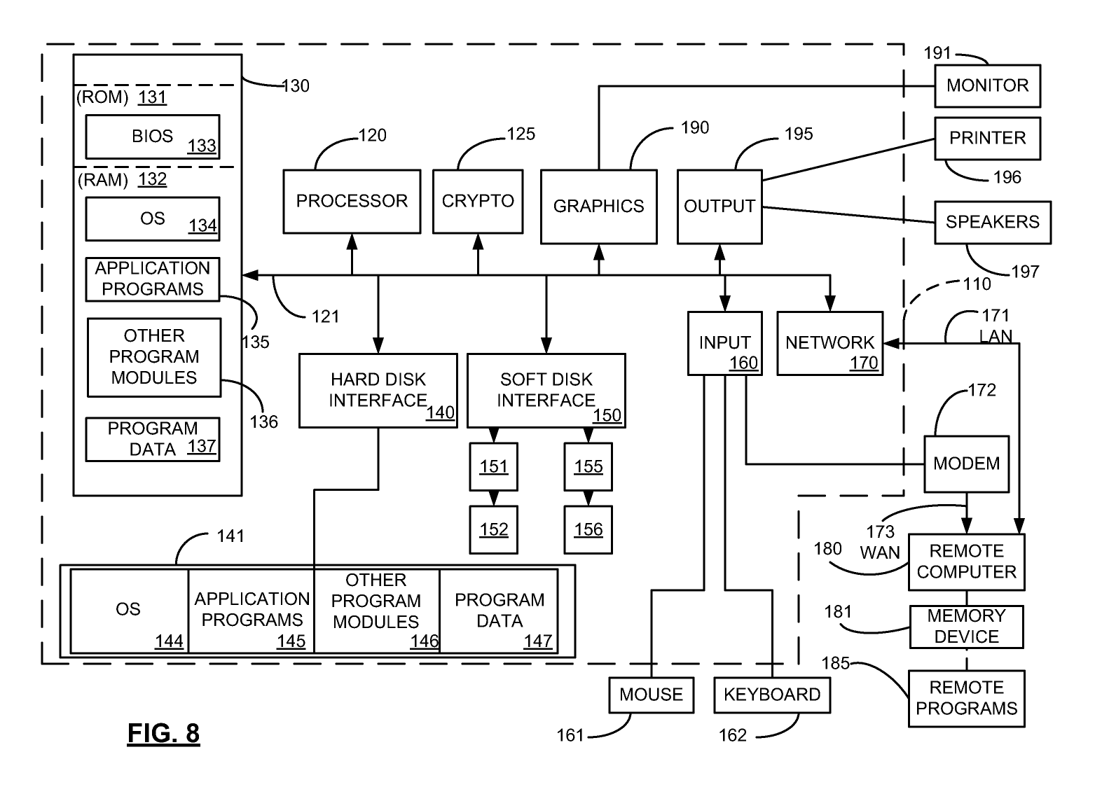

A skilled artisan will note that one or more of the aspects of the present invention may be performed on a computing device. The skilled artisan will also note that a computing device may be understood to be any device having a processor, memory unit, input, and output. This may include, but is not intended to be limited to, cellular phones, smart phones, tablet computers, laptop computers, desktop computers, personal digital assistants, etc. FIG. 8 illustrates a model computing device in the form of a computer 110, which is capable of performing one or more computer-implemented steps in practicing the method aspects of the present invention. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 110 may also include a cryptographic unit 125. Briefly, the cryptographic unit 125 has a calculation function that may be used to verify digital signatures, calculate hashes, digitally sign hash values, and encrypt or decrypt data. The cryptographic unit 125 may also have a protected memory for storing keys and other secret data. In other embodiments, the functions of the cryptographic unit may be instantiated in software and run via the operating system.

A computer 110 typically includes a variety of computer readable media. Computer readable media can be any available media that can be accessed by a computer 110 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 8 illustrates an operating system (OS) 134, application programs 135, other program modules 136, and program data 137.

The computer 110 may also include other removable/non-removable, volatile/nonvolatile computer storage media. By way of example only, FIG. 8 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives, and their associated computer storage media discussed above and illustrated in FIG. 8, provide storage of computer readable instructions, data structures, program modules and other data for the computer 110. In FIG. 8, for example, hard disk drive 141 is illustrated as storing an OS 144, application programs 145, other program modules 146, and program data 147. Note that these components can either be the same as or different from OS 134, application programs 135, other program modules 136, and program data 137. The OS 144, application programs 145, other program modules 146, and program data 147 are given different numbers here to illustrate that, at a minimum, they may be different copies. A user may enter commands and information into the computer 110 through input devices such as a keyboard 162 and cursor control device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 8. The logical connections depicted in FIG. 8 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 8 illustrates remote application programs 185 as residing on memory device 181.

The communications connections 170 and 172 allow the device to communicate with other devices. The communications connections 170 and 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed.

What is claimed is:

1. A method of tuning a luminaire having a first light source, a second light source, and a third light source, wherein each light source produces a different color of light, the method comprising the steps of:
operating each of first light source, the second light source, and the third light source;
receiving a selected warmth;
determining whether the light emitted by the first light source matches the amount of light needed from the first light source to match the selected warmth, wherein a determination that the light emitted by the first light source does not match the amount of light needed from the first light source results in operating the first light source to emit the amount of light needed from the first light source to match the selected warmth;
determining whether the light emitted by the second light source matches the amount of light needed from the second light source to match the selected warmth, wherein a determination that the light emitted by the second light source does not match the amount of light needed from the second light source results in operating the second light source to emit the amount of light needed from the second light source to match the selected warmth; and
determining whether the light emitted by the third light source matches the amount of light needed from the third light source to match the selected warmth, wherein a determination that the light emitted by the third light source does not match the amount of light needed from the third light source results in operating the third light source to emit the amount of light needed from the third light source to match the selected warmth.

2. A method according to claim 1 wherein the step of receiving a selected warmth comprises receiving a warmth from a user via a computerized device having a user interface, the method further comprising the steps of:
presenting to the user a confirmation message via the user interface; and
receiving a confirmation input from the user;
wherein an affirmative confirmation input results in continued operation of the first light source, the second light source, and the third light source; and
wherein a negative confirmation input results in a retuning operation of the luminaire.

3. A method according to claim 1 wherein the step of receiving a selected warmth comprises receiving a warmth from a user via a computerized device having a user interface, the method further comprising the step of receiving a value for an adjustment to the light emission of at least one of the first light source, the second light source, and the third light source from the user interface.

4. A method according to claim 1 wherein the first light source is a mint-white-light producing light source; wherein the second light source is a blue light-producing light source; and wherein the third light source is an amber light-producing light source.

5. A method according to claim 1 further comprising the steps of:
receiving a selected dominant color; and
adjusting the selected warmth to include the selected dominant color.

6. A method according to claim 5 wherein the step of adjusting the selected warmth to include the selected dominant color comprises increasing or decreasing emission of at least one of the first light source, the second light source, and the third light source.

7. A method according to claim 5 wherein the step of adjusting the selected warmth to accentuate the selected dominant color comprises increasing the light emitted by the one of the first light source, the second light source, and the third light source that is closest in color to the selected dominant color.

8. A method according to claim 5 wherein the computerized device comprises an image capture device, and wherein the step of receiving a selected dominant color comprises:
capturing an image of the environment by the image capture device; and
determining a dominant color from the captured image.

9. A method of tuning a luminaire having a first light source, a second light source, and a third light source using a computerized device having a user interface, the method comprising the steps of:
operating each of first light source, the second light source, and the third light source;
receiving a selected warmth via the user interface;
determining whether the light emitted by the first light source matches the amount of light needed from the first light source to match the selected warmth;
wherein a determination that the light emitted by the first light source does not match the amount of light needed from the first light source results in operating the first light source to emit the amount of light needed from the first light source;
determining whether the light emitted by the second light source matches the amount of light needed from the second light source to match the selected warmth;
wherein a determination that the light emitted by the second light source does not match the amount of light needed from the second light source results in operating the second light source to emit the amount of light needed from the second light source to match the selected warmth;
determining whether the light emitted by the third light source matches the amount of light needed from the third light source to match the selected warmth;
wherein a determination that the light emitted by the third light source does not match the amount of light needed from the third light source results in operating the third light source to emit the amount of light needed from the third light source;
receiving a selected dominant color; and
adjusting the selected warmth to include the selected dominant color.

10. A method according to claim 9 further comprising the step of receiving a value for an adjustment to the light emission of at least one of the first light source, the second light source, and the third light source from the user interface.

11. A method according to claim 9 wherein the step of adjusting the selected warmth to include the selected dominant color comprises increasing or decreasing the emission of at least one of the first light source, the second light source, and the third light source.

12. A method according to claim 9 wherein the step of adjusting the selected warmth to include the selected dominant color comprises increasing the light emitted by the one of the first light source, the second light source, and the third light source that is closest in color to the selected dominant color.

13. A method according to claim 9 wherein the computerized device comprises an image capture device, and wherein the step of receiving a selected dominant color comprises:
capturing an image of the environment by the image capture device; and
determining a dominant color from the captured image.

14. A tunable lighting system comprising:
a luminaire comprising:
a mint-white light-emitting diode (LED);
a first colored LED;
a second colored LED; and
a controller; and
a computerized device positioned in communication with the controller and configured to control the operation of each of the mint-white LED, the first colored LED, and the second colored LED,
wherein the computerized device comprises a user interface configured to receive a selected warmth; and
wherein the controller is programmable to operate the LEDs of the luminaire responsive to the selected warmth.

15. A tunable lighting system according to claim 14 wherein the computerized device further comprising an image capture device; and wherein the computerized device is programmable to capture an image of an environment using the image capture device, determine a dominant color of the captured image, and cause the controller to operate the luminaire responsive to the dominant color.

16. A tunable lighting system according to claim 15 wherein the computerized device is a mobile phone.

17. A tunable lighting system according to claim 14 wherein the first colored LED is a blue LED; and wherein the second colored LED is an amber LED.

18. A tunable lighting system according to claim 14 wherein the user interface is configured to request confirmation of a warmth of the luminaire from a user.

19. A tunable lighting system according to claim 14 wherein the user interface is configured to receive selected levels of operation for each of the mint-white LED, the first colored LED, and the second colored LED; and wherein the computerized device is configured to cause the controller to operate the LEDs responsive to the received selected level of operation for the mint-white LED, the first colored LED, and the second colored LED.

20. A tunable lighting system according to claim 19 wherein the controller controls the level of operation of each of the mint-white LED, the first colored LED, and the second colored LED through pulse-width modulation (PWM).
